(19) United States
(12) Patent Application Publication
(10) Pub. No.: US 2009/0174109 A1
(43) Pub. Date: Jul. 9, 2009

(54) Composite Material Containing Wood and Melamine Resin

(76) Inventors: Manfred Ratzsch, Altenberg bei Linz (AT); Andreas Endesfelder, Linz (AT); Uwe Muller, Luftenberg (AT); Andreas Haider, Linz (AT); Huong Lan Nguyen, Linz (AT); Melanie Steiner, Taufkirchen/Trattnach (AT)

Correspondence Address: THE WEBB LAW FIRM, P.C., 700 KOPPERS BUILDING, 436 SEVENTH AVENUE, PITTSBURGH, PA, 15219, US

(21) Appl. No.: 11/922,432

(22) PCT Filed: Jun. 19, 2006
(86) PCT No.: PCT/EP2006/006186

§ 371 Date: Feb. 11, 2009

(30) Foreign Application Priority Data
Jun. 20, 2005 (DE) 10 2005 029 685.8

(51) Int. Cl. B29C 47/12; C08L 97/02; B32B 27/08; B29C 47/00

(52) U.S. Cl. 264/173.19; 524/14; 264/171.1

(57) ABSTRACT

The invention relates to composite material containing a proportion of wood and a proportion of crosslinked melamine resins, which is characterized in that the crosslinked melamine resins are formed from melamine resins that are, in essence, linearly synthesized and have a shear-dependent viscosity. The invention also relates to a method for producing the composite materials and to the use thereof.

The invention relates to a composite material as claimed in the precharacterizing part of claim 1, to a process for its production as claimed in claim 14, and to its use as claimed in claim 18.

Various composite materials which comprise plastics and wood have been described.

For example, composite materials composed of wood and thermoplastics are known. EP 1172404 B1 describes composites composed of polypropylene, polyethylene, or polystyrene with content of from 20 to 80% by weight of wood fibers. The disadvantage of composite materials comprising thermoplastics is limited strength and toughness as a consequence of the low compatibility of the apolar polyolefins with the wood component.

Mixtures composed of melamine resins and wood particles have likewise been previously described. For example, JP 52 005 854 A2 describes the use of wood powder as filler in melamine molding compositions. Low flexibility due to the use of melamine resins is a disadvantage in composite materials.

The varying melting behavior and flow behavior of melamine resins also has an effect on the properties of composite materials which comprise melamine resins.

Addition of thermoplastics as lubricants is known for improving the viscosity and flexibility of composite materials using melamine resins.

For example, WO 2005/009701 describes a composite material composed of from 55 to 90% by weight of wood particles and from 45 to 10% by weight of crosslinked plastics, where the crosslinked plastics are either crosslinked melamine resin ethers composed of melamine resins etherified using alcohols (MER type) or composed of melamine resins transetherified using alcohols (MPER type), or are a mixture composed of partially crosslinked thermoplastics and of crosslinked melamine resin ethers. Examples of preferred partially crosslinked thermoplastics are partially crosslinked ethylene-vinyl acetate copolymers, and partially crosslinked polyethers and/or polyesters.

Addition of partially crosslinked thermoplastics can give a homogeneous melt of the composite material with good flow properties, the melt being suitable for thermoplastic processing, e.g. in extruders. However, a disadvantage for the use of this type of composite material is the poor mechanical properties of the admixed thermoplastics.

An object on which the invention is based is therefore to provide a composite material which has good flow behavior and good compactability between melamine resin and wood, but at the same time exhibits good mechanical properties.

A composite material with the features of claim 1 achieves this object.

The inventive composite material with a proportion of wood and a proportion of crosslinked melamine resins is characterized in that the crosslinked melamine resins are formed from melamine resins which in essence have linear structure and have shear-dependent viscosity.

The melamine resins which in essence have linear structure take the form of linear or weakly crosslinked chain molecules whose structure in essence corresponds to that of the melamine resins described in a parallel application (easy-flow melamine resins). These chain molecules can flow past one another if the temperature is sufficiently high, and this makes the resin fusible and makes its viscosity shear-rate-dependent. This property is also termed non-newtonian behavior. Since these resins have very good flow behavior in the melt phase, the wood particles can be homogeneously dispersed in the resin matrix in the inventive composite materials. It is no longer necessary to add partially crosslinked thermoplastics as lubricants. The inventive composite material features not only good thermoplastic processability but also improved mechanical properties.

The inventive composite material advantageously encompasses a proportion of wood of from 40 to 85% by weight, a proportion of crosslinked melamine resins of from 15 to 60% by weight, and a proportion of additives of from 0 to 20% by weight. The composite material preferably has from 50 to 80% by weight of wood, from 18 to 48% by weight of crosslinked melamine resins, and from 2 to 10% by weight of additives.

Advantageously, the molecular weights of the melamine resins which in essence have linear structure and have shear-dependent viscosity are from 1000 to 200 000.

The inventive composite material preferably comprises melamine resins synthesized from triazine rings of (B₂N)_{b}—X—(NHA)ₐ type, where a+b=3 and 0≦b≦2, X is a triazine ring, and each of A and B is a —CH₂OR group having a moiety R composed of any desired alkanol, diol, or polyol. Additives that can be used with advantage are uncrosslinked thermoplastics, lubricants, or further additives, such as flame retardants, pigments, stabilizers, catalysts, UV absorbers, and/or free-radical scavengers, individually, or a mixture of these.

The additive used preferably comprises a mixture composed of uncrosslinked thermoplastic and lubricant, where the amount of uncrosslinked thermoplastic is at most 20% by weight, based on the melamine resin in the composite material. This corresponds to thermoplastic content of at most 12% by weight, based on the composite material. At higher thermoplastics concentrations, based on the melamine resin, the thermoplastic functions as binder matrix. This means that the melamine resin becomes included by the thermoplastic, which determines the mechanical properties of the composite.

The additive used particularly preferably comprises a mixture composed of uncrosslinked thermoplastic and lubricant, the amount of additive being at most 5% by weight and the amount of uncrosslinked thermoplastic being at most 2% by weight, based in each case on the composite material.

In principle, a very wide variety of uncrosslinked thermoplastics can be used as additive. Uncrosslinked thermoplastics used in the composite material preferably comprise ethylene-vinyl acetate (EVA) or polycaprolactone.

The lubricants used preferably comprise hydrocarbon waxes, oxidized hydrocarbon waxes, zinc stearate, calcium stearate, magnesium stearate, or other metal soaps and/or mixtures composed of these.

The proportion of wood in the inventive composite advantageously takes the form of wood flour, wood particles, wood pellets, wood fibers, and/or wood shavings.

It is preferable that the inventive composite material comprises fillers of the type represented by melamine, urea, cellulose, urea-formaldehyde resins, melamine-formaldehyde resins, polyether polyols, and/or polyester polyols.

The inventive composite material preferably takes the form of a sheet, profile, or tube.

The object of the invention is also achieved via a process for production of a composite material as claimed in claim 1, and its use.

The inventive composite material with a proportion of wood and with a proportion of crosslinked melamine resins is produced by a process where the wood, the melamine resins which in essence have linear structure and have shear-dependent viscosity, and additives are melted, homogenized, and devolatilized at temperatures of about 90 to 170° C.,
the mixture is compressed at a melt temperature of about 100 to 150° C.,
and is then introduced, with a temperature increase to 180-300° C., into a shaping die in which the crosslinking takes place, and
the finished composite material is discharged, where, between the compression section and the shaping section, the mixture passes through a thermal separation stage, which inhibits heat transfer between the compression section and the shaping section.

Advantageously, the wood, the melamine resins in essence having linear structure and having shear-dependent viscosity, and additives are melted, homogenized, and devolatilized in an extruder, particularly preferably in a conical twin-screw extruder. It is also possible to use a mixer or compounder for the homogenization, melting, and devolatilizing process. The compression of the mixture takes place in the extruder.

It is preferable that the metering of wood, of melamine resins in essence having linear structure and having shear-dependent viscosity, and of additives into the extruder takes place in the form of the individual components or in the form of a flowable mixture prepared from the individual components.

The inventive composite materials are preferably used in windows, in doors, in cladding elements, and in roof elements in the outdoor sector, and also in the sports and leisure sector for garden furniture, and outdoor seating, and for design of childrens' play areas.

The invention is explained in more detail below with reference to a number of inventive examples and figures.

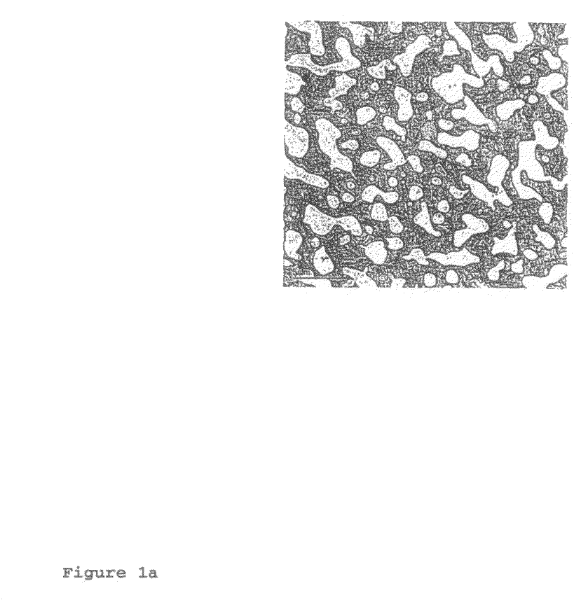

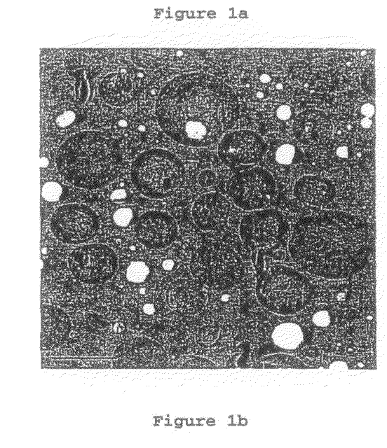

FIGS. 1a and 1b: show transmission electron micrographs of a melamine-resin-thermoplastic mixture;

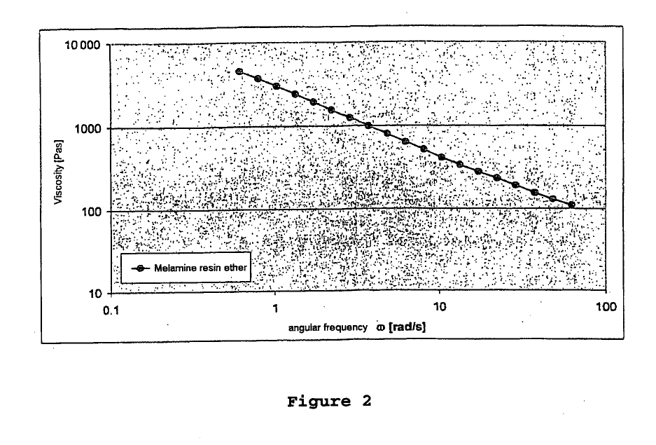

FIG. 2: shows a diagram describing the viscosity of the melamine resin ether as a function of shear, and

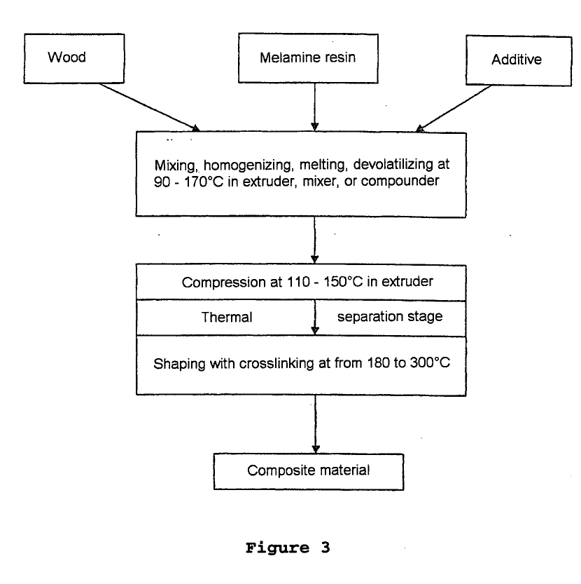

FIG. 3: shows a plan of the sequence of the production process for one embodiment of the inventive composite materials.

### INVENTIVE EXAMPLE 1

### 1.1 Preparation of the Wood-Melamine-Resin Premixes

17.6 kg of spruce-wood shavings are compounded in a high-speed mixer with 4.1 kg of melamine resin ether, 0.54 kg of polycaprolactone, and 3% by weight of Naftosafe PHX 369D (CHEMSON), based on the total amount, for 8 min at 90° C.

The melamine resin ethers here are prepared on the basis of an MER (M:F=1:4), these being transetherified using 30% by weight of SIMULSOL® BPPE polyester polyol (Seppic) and compounded using 50% by weight of MER (M:F=1:2.5). The M_{w} of the melamine resin ethers is ˜8000 g/mol and they have shear-dependent viscosity of 45 Pa*s, measured at 130° C.

A further 4.1 kg of this melamine resin ether are then metered into the premix, and the mixture is mixed for a further 4 min. In the subsequent cooling mixer, this mixture is cooled to about 40° C. and finished.

### 1.2 Production of the Crosslinked Plastics Product

35 kg/h of the premix prepared in 1.1 is metered into the feed hopper of a Fiberex T58 Cincinnati extruder with conical twin screw, vacuum devolatilization and a sheet die (4.6×160 mm), and melted at 130° C. This material is then homogenized and hardened using a temperature profile of 130/130/130/110/110/110///125/225/225/225° C. in the extruder and the die.

The density of test specimens milled from the extruded wood-melamine-resin composites is 1.32 g/cm³ and their flexural modulus is 72 N/mm².

### INVENTIVE EXAMPLE 2

### 2.1 Preparation of the Wood-Melamine-Resin Premixes

16.2 kg of spruce-wood shavings are sintered in a high-speed mixer with 4.7 kg of melamine resin ether, 1.35 kg of polycaprolactone, and 3% by weight of Naftosafe PHX 369D (CHEMSON), based on the total amount, for 9 min at 95° C.

The melamine resin ethers here are prepared on the basis of an MER (M:F=1:4), these being transetherified using 30% by weight of DESMOPHEN 800 polyester polyol (Bayer) and compounded using 50% by weight of MER (M:F=1:2.5). The M_{w} of the melamine resin ethers is ˜15 000 g/mol and they have shear-dependent viscosity of 90 Pa*s, measured at 130° C.

A further 4.0 kg of this melamine resin ether are then metered into the mixture and the mixture is mixed for a further 6 min. In the subsequent cooling mixer, this mixture is cooled to about 50° C. and finished.

### 2.2 Production of the Crosslinked Plastics Product

75 kg/h of the premix prepared in 2.1 is metered into the feed hopper of a Fiberex T58 Cincinnati extruder with conical twin screw, vacuum devolatilization and a sheet die (4.6×160 mm), and melted at 125° C. This material is then homogenized and hardened using a temperature profile of 125/125/125/120/120/120///125/225/225/225° C. in the extruder and the die.

The density of test specimens milled from the extruded wood-melamine-resin composites is 1.29 g/cm³ and their flexural modulus is 55 N/mm².

### INVENTIVE EXAMPLE 3

### 3.1 Preparation of Wood-Melamine-Resin Premixes

16.2 kg of spruce-wood shavings are sintered in a high-speed mixer with 6.0 kg of melamine resin ether, 1.5% by weight of Naftosafe PHX 369D, and 1.5% by weight of Naftosafe PHX 369D20 (both CHEMSON), in each case based on the total amount, for 9 min at 105° C.

The melamine ethers here are prepared on the basis of an MER (M:F=1:3), these being transetherified using 15% by weight of CAPA 3091 polyester polyol (SOLVAY). The M_{w} of the melamine resin ethers is ˜10 500 g/mol and they have shear-dependent viscosity of 60 Pa*s, measured at 130° C.

A further 4.0 kg of this melamine resin ether are then metered into the mixture and the mixture is mixed for a further 6 min. In the subsequent cooling mixer, this mixture is cooled to about 50° C. and finished.

### 3.2 Production of the Crosslinked Plastics Product

55 kg/h of the premix prepared in 3.1 is metered into the feed hopper of a Fiberex T58 Cincinnati extruder with conical twin screw, vacuum devolatilization and a sheet die (4.6×160 mm), and melted at 110° C. This material is then homogenized and hardened using a temperature profile of 110/110/110/110/110/110///125/235/235/235° C. in the extruder and the die.

The density of test specimens milled from the extruded wood-melamine-resin composites is 1.34 g/cm³ and their flexural modulus is 68 N/mm².

### INVENTIVE EXAMPLE 4

### 4.1 Preparation of the Wood-Melamine-Resin Premixes

18.9 kg of beech-wood shavings are sintered in a high-speed mixer with 0.54 kg of polycaprolactone and 3% by weight of magnesium stearate, based on the total amount, for 8 min at 97° C. 6.75 kg of melamine resin ether are then metered in and the mixture is mixed for a further 5 min.

The melamine ethers here are prepared on the basis of an MER (M:F=1:3.5), these being transetherified using 15% by weight of PEG 1000 polyether polyol. The M_{w} of the melamine resin ethers is ˜12 000 g/mol and they have shear-dependent viscosity of 73 Pa*s, measured at 130° C.

In the subsequent cooling mixer, the wood-melamine premix is cooled to about 45° C. and finished.

### 4.2 Production of the Crosslinked Plastics Product

70 kg/h of the premix prepared in 4.1 is metered into the feed hopper of a DS 13.27 Weber extruder with parallel twin screw, vacuum devolatilization and a sheet die (4.6×160 mm), and melted at 125° C. This material is then homogenized at a temperature of 125° C. throughout the extruder and hardened in the die at 240° C.

The density of test specimens milled from the extruded wood-melamine-resin composites is 1.25 g/cm³ and their flexural modulus is 59 N/mm².

### INVENTIVE EXAMPLE 5

### 5.1 Preparation of the Wood-Melamine-Resin Premixes

12.2 kg of mixed-wood shavings are sintered in a high-speed mixer with 7 kg of a melamine resin ether and 3% by weight of Naftosafe THX 369D, based on the total amount, for 8.5 min at 103° C.

The melamine ethers used here are prepared on the basis of an MER (M:F=1:4), these being transetherified using 15% by weight of butanediol. The M_{w} of the melamine resin ethers is ˜8000 g/mol and they have shear-dependent viscosity of 50 Pa*s, measured at 130° C.

A further 7 kg of the melamine resin ethers are then metered into the premix, and the mixture is mixed for a further 6 min. In the subsequent cooling mixer, this mixture is cooled to about 50° C. and finished.

### 5.2 Production of the Crosslinked Plastics Product

50 kg/h of the premix prepared in 5.1 is metered into the feed hopper of a Cincinnati Proton-25 B extruder with vacuum devolatilization and a sheet die (4.6×160 mm), and melted at 120° C. This material is then homogenized at a temperature of 120° C. throughout the extruder and hardened in the die at 230° C.

The density of test specimens milled from the extruded wood-melamine-resin composites is 1.27 g/cm³ and their flexural modulus is 63 N/mm².

### INVENTIVE EXAMPLE 6

### 6.1 Production of the Crosslinked Plastics Product

40 kg/h of the following individual components:
26 kg of spruce-wood shavings
12 kg of melamine resin ether
0.8 kg of polycaprolactone, and
1.2 kg of Naftosafe PHX 369D (CHEMSON) are metered volumetrically into the feed hopper of a Fiberex T58 Cincinnati extruder with conical twin screw, vacuum devolatilization, and a sheet die (4.6×160 mm) and melted at 135° C.

The melamine resin ethers here are prepared on the basis of an MER (M:F=1:4), these being transetherified using 30% by weight of SIMULSOL® BPPE polyester polyol (Seppic) and using 50% by weight of MER (M:F=1:2.5). The M_{w} of the melamine resin ethers is ˜8000 g/mol and they have shear-dependent viscosity of 45 Pa*s, measured at 130° C.

This material is then homogenized and hardened using a temperature profile of 135/135/120/110/110/-110////125/225/225/225° C. in the extruder and the die.

The density of test specimens milled from the extruded wood-melamine-resin composites is 1.29 g/cm³ and their flexural modulus is 62 N/mm².

FIGS. 1a and 1b show transmission electron micrographs of a melamine resin/thermoplastics mixture prepared using CAPA® 6400 thermoplastic (Solvay), using 3900-times magnification.

FIG. 1a is the micrograph of a melamine resin/thermo-plastics mixture (CAPA® 6400, polycaprolactone, Solvay), where about 33% by weight of CAPA® 6400 were admixed. That corresponds to an MPER:CAPA® 6400 ratio of 2:1. It is clearly seen that CAPA® 6400 (dark regions, lamellar structure) forms the matrix and that melamine resin has been embedded therein (white regions). The melamine resin has therefore been included by the thermoplastic. A consequence of this is that the mechanical and thermal properties of the composite are determined by the thermoplastic, i.e. the composite is characterized by the poor mechanical properties, undesirable here, of the thermoplastics.

FIG. 1b shows the micrograph of a melamine resin/thermo-plastics mixture using about 17% by weight of CAPA® 6400 and using an MPER:CAPA® ratio of 5:1. The phase inversion is clearly discernible, and this means that here the melamine resin forms the matrix and the thermoplastic has been embedded in the melamine resin (CAPA® 6400; dark circles, lamellar structure). The mechanical properties of the composite are therefore determined by the mechanical properties of the melamine resins, and the composite material therefore has improved hardness and strength.

FIG. 2 uses a graph to show the functional relationship between viscosity of the melamine resin ether and shear, measured at 130° C. It can be seen that, within the shear range tested, the prevailing dependency of viscosity on shear rate is almost linear, and this is termed “non-newtonian” behavior.

FIG. 3 summarizes the steps for production of one embodiment of the inventive composite material. In a first step of the process, wood, melamine resin and additives are melted, mixed, homogenized, and devolatilized in an extruder, mixer, or compounder, at temperatures from 90 to 170° C. In a second step, compression of the melt in the extruder at from 110 to 150° C. and thermal separation take place. In the next step of the process, the melt is introduced into a shaping die at temperatures from 180 to 300° C. This temperature increase brings about complete crosslinking and therefore hardening of the melamine resin. In a final step, the molded composite material is discharged and cooled.

1-18. (canceled)

19. A composite material with a proportion of wood and with a proportion of crosslinked melamine resins, comprising:
melamine resins which in essence have linear structure and have shear-dependent viscosity are prepared from triazine rings of (B₂N)_{b}—X—(NHA)ₐ type, where a+b=3 and 0≦b≦2, X is a triazine ring, and each of A and B is a —CH₂OR group having a moiety R composed of any desired alkanol, diol, or polyol, wherein
crosslinked melamine resins are formed from melamine resins which in essence have linear structure and have shear-dependent viscosity, and wherein
the composite material has a proportion of wood of from 40 to 85% by weight, a proportion of crosslinked melamine resins of from 15 to 60% by weight, and a proportion of additives of from 0 to 20% by weight.

20. The composite material as claimed in claim 19, wherein a proportion of wood of from 50 to 80% by weight, a proportion of crosslinked melamine resins of from 18 to 48% by weight, and a proportion of additives of from 2 to 10% by weight are present.

21. The composite material as claimed in claim 19, wherein the molecular weights of the melamine resins which in essence have linear structure and have shear-dependent viscosity are from 1000 to 200 000.

22. The composite material as claimed in claim 19, wherein the additives used are at least one of uncrosslinked thermoplastics, lubricants, flame retardants, pigments, stabilizers, catalysts, UV absorbers, or free-radical scavengers.

23. The composite material as claimed in claim 19, wherein the additives used are a mixture composed of uncrosslinked thermoplastic and lubricant, wherein the amount of uncrosslinked thermoplastic is at most 20% by weight, based on the melamine resin in the composite material.

24. The composite material as claimed in claim 19, wherein the additives used are a mixture composed of uncrosslinked thermoplastic and lubricant, the amount of additive being at most 5% by weight and the amount of uncrosslinked thermoplastic being at most 2% by weight, based in each case on the composite material.

25. The composite material as claimed in claim 22, wherein the uncrosslinked thermoplastics comprise ethylene-vinyl acetate (EVA) or polycaprolactone.

26. The composite material as claimed in claim 22, wherein the lubricants are at least one of hydrocarbon waxes, oxidized hydrocarbon waxes, zinc stearate, calcium stearate, magnesium stearate, other metal soaps or mixtures thereof.

27. The composite material as claimed in claim 19, wherein the proportion of wood takes the form of wood flour, wood particles, wood pellets, wood fibers, wood shavings, or a combination thereof.

28. The composite material as claimed in claim 19, wherein composite material comprises fillers consisting of melamine, urea, cellulose, urea-formaldehyde resins, melamine-formaldehyde resins, polyether polyols, polyester polyols, or mixtures thereof.

29. The composite material as claimed in claim 19, wherein the composite material takes the form of a sheet, profile, or tube.

30. A process for production of a composite material as claimed in claim 19, comprising the steps of:
melting, homogenizing, and devolatilizing the wood, the melamine resins which in essence have linear structure and have shear-dependent viscosity, and additives at temperatures of about 90 to 170° C.,
compressing the mixture at a melt temperature of about 100 to 150° C.,
introducing the compressed mixture, with a temperature increase to 180-300° C., into a shaping die in which the crosslinking takes place, and
discharging the finished composite material, wherein, between the compression section and the shaping section, the mixture passes through a thermal separation stage, which inhibits heat transfer between the compression section and the shaping section.

31. The process as claimed in claim 30, wherein the wood, the melamine resins in essence having linear structure and having shear-dependent viscosity, and additives are melted, homogenized, and devolatilized in an extruder, and the mixture is then compressed in an extruder.

32. The process as claimed in claim 31, wherein the extruder is a conical twin-screw extruder.

33. The process as claimed in claim 31, wherein the metering of wood, of melamine resins in essence having linear structure and having shear-dependent viscosity, and of additives into the extruder takes place in the form of the individual components or in the form of a flowable mixture prepared from the individual components.
